(19) United States
(12) Patent Application Publication
(10) Pub. No.: US 2018/0109881 A1
(43) Pub. Date: Apr. 19, 2018

(54) HEARING AID AND SIGNAL PROCESSING DEVICE FOR A HEARING AID

(71) Applicant: SIVANTOS PTE. LTD., SINGAPORE (SG)

(72) Inventors: ZHENG ZHONG CHEW, MALAYSIA TANGKAK JOHORE (MY); HOCK PENG LIM, SINGAPORE (SG); MENG KIANG LIM, SINGAPORE (SG); SITI HAJAR RAHMAN, SINGAPORE (SG); WEE LENG TAN, SINGAPORE (SG); HONG CHING TAY, SINGAPORE (SG)

(21) Appl. No.: 15/787,100

(22) Filed: Oct. 18, 2017

(30) Foreign Application Priority Data
Oct. 18, 2016 (DE) 102016220432.7

(51) Int. Cl. H04R 25/00

(52) U.S. Cl. CPC H04R 25/402; H04R 2225/51; H04R 25/65; H04R 25/60

(57) ABSTRACT

A hearing aid includes an acoustoelectric transducer, a signal processing device and an electroacoustic transducer. The signal processing device has a flexible printed circuit board provided with electronic components. The printed circuit board is bent to form an approximately G-shaped stacked configuration. The stacked configuration of the printed circuit board has three horizontal limbs disposed above one another along a stacking direction. The outer horizontal limbs are connected to one another by a first printed circuit board section and one of the outer limbs and the middle limb are connected to one another by a second printed circuit board section. The first printed circuit board section is reinforced along the stacking direction and the horizontal limbs in the stacked configuration are spaced apart from one another along the stacking direction.

### CROSS-REFERENCE TO RELATED APPLICATION

This application claims the benefit, under 35 U.S.C. § 119, of German patent application DE 10 2016 220 432.7, filed Oct. 18, 2016; the prior application is herewith incorporated by reference in its entirety.

### BACKGROUND OF THE INVENTION

### Field of the Invention

The invention relates to a hearing aid having an acoustoelectric transducer, a signal processing device and an electroacoustic transducer, and the signal processing device has a flexible printed circuit board provided with electronic components. The invention further relates to a signal processing device for a hearing aid.

Hearing aids are portable hearing apparatuses that are used for the care of the hard of hearing or aurally handicapped. In order to meet the numerous individual needs, different constructions of hearing aids are provided, such as behind-the-ear hearing aids (BTE) and hearing aids with an external receiver (RIC: receiver in the canal) and in-the-ear hearing aids (ITE), e.g. including concha hearing aids or channel hearing aids (ITE: in-the-ear, CIC: completely-in-channel, IIC: invisible-in-the-channel). The hearing aids mentioned by way of example are worn on the external ear or in the auditory canal of a hearing aid user. Furthermore, bone-conduction hearing aids, implantable hearing aids or vibrotactile hearing aids are also commercially available. In that case, the damaged hearing is stimulated either mechanically or electrically.

In principle, the important components of hearing aids are an input transducer, an amplifier and an output transducer. The input transducer is normally an acoustoelectric transducer, e.g. a microphone, and/or an electromagnetic receiver, e.g. an induction coil or a radio frequency (RF) antenna. The output transducer is generally realized as an electroacoustic transducer, e.g. a miniature loudspeaker (receiver), or an electromechanical transducer, e.g. a bone-conduction receiver. The amplifier is usually integrated in a signal processing device. The power supply is usually provided by a battery or a rechargeable battery.

Hearing aids are preferably embodied to be particularly space-saving and compact, with the result that they can be worn by a hearing aid user in as inconspicuous a manner as possible. As a result, it is necessary for the installation space of the hearing aid to be used as effectively as possible so that the components are disposed in a compact housing of the hearing aid in the most space-saving manner possible.

It is known, for example from U.S. Pat. No. 6,674,869 B2, to use a foldable or bendable printed circuit board (substrate) as an electronics carrier for that purpose. In that case, the printed circuit board is bent or folded in a space-saving manner in an approximately G-shaped or e-shaped configuration. In that case, the known printed circuit board has three straight, in particular mechanically stable, limbs as carriers for electronic component parts and components, which are disposed substantially parallel to one another. The three limbs are coupled to one another by using two flexible or bendable arched printed circuit board sections. In that case, in the bent or folded state of the printed circuit board, the middle limb abuts one of the outer limbs. Installation space in the hearing aid is saved by the folded or bent configuration of the printed circuit board.

A flexible printed circuit board that is folded in a G-shaped or e-shaped manner is known from German Publication DE 10 2008 022 977 A1. Before folding, a self-adhesive encapsulation is applied to the surface of the printed circuit board. When the printed circuit board is folded or bent, the three limbs are secured to one another by the encapsulation. The encapsulation acts in that case on the bent shape of the printed circuit board in a mechanically supportive and stabilizing manner.

In particular, the arched printed circuit board section that connects the two outer limbs to one another has an approximately C-shaped contour in the bent state. Due to that bending (curving, arching), the installation space between the outer limbs that is bordered by the printed circuit board section is disadvantageously restricted, as a result of which an increased space requirement along the limb direction is created and therefore a larger printed circuit board has to be used. As a consequence, that is disadvantageously passed on to the physical size and manufacturing costs of the hearing aid.

### SUMMARY OF THE INVENTION

It is accordingly an object of the invention to provide a hearing aid and a signal processing device for a hearing aid, which overcome the hereinafore-mentioned disadvantages of the heretofore-known devices of this general type, which are suitable and which save the most space possible and/or configure the installation space most effectively. It is preferably intended for the greatest possible number of electronic components to be able to be mounted on the printed circuit board, given the most compact possible construction or most compact possible configuration of the printed circuit board at the same time.

With the foregoing and other objects in view there is provided, in accordance with the invention, a hearing aid including an acoustoelectric transducer, an electroacoustic transducer and a signal processing device. The signal processing device includes a printed circuit board (substrate) provided with electronic components. The printed circuit board is flexible or bendable at least in sections. In the mounted state, the printed circuit board is bent or folded to form an approximately G-shaped or e-shaped stacked configuration.

The stacked configuration of the printed circuit board has three horizontal limbs disposed above one another along a stacking direction as carriers for the electronic components. For this purpose, the limbs are embodied, for example, as non-flexible conductor track sections, so that the components are carried securely and easily on the printed circuit board. The outer horizontal limbs are connected to one another by using a first printed circuit board section and one of the outer limbs and the middle limb are connected to one another by using a second printed circuit board section. The first printed circuit board section is constructed in this case to be preferably mechanically reinforced along the stacking direction. In addition, the horizontal limbs of the stacked configuration are each disposed so as to be spaced apart from one another along the stacking direction.

A particularly compact and installation space-saving stacked configuration of the printed circuit board is made possible by reinforcing the first printed circuit board section. As a consequence, this advantageously translates to a reduction in the physical size and manufacturing costs of the hearing aid.

In one suitable embodiment, the, in particular thin, printed circuit board therefore has fixed conductor track sections as limbs and flexible conductor track sections as connection pieces in between. The flexible or bendable first and second conductor track sections are manufactured in this case, for example, based on polyamide films. However, it is also conceivable, for example, for the entire printed circuit board to be constructed as a bendable flexible circuit.

The limbs of the stacked configuration are suitably oriented along a limb direction directed substantially perpendicularly to the stacking direction and preferably embodied in a straight line. By virtue of the limbs being disposed, in particular, in each case spaced apart from one another, approximately six mounting or carrier faces for the components of the printed circuit board are formed by the limb plane sides (top side, bottom side).

In this case, the components include, in particular, passive components, such as capacitors, coils, resistors, crystal oscillators, and active components, such as switching elements (transistors), integrated circuits and control units, for example in the form of a microcontroller or an application-specific integrated circuit (ASIC). The stacked configuration of the printed circuit board provides a particularly compact packing or carrier structure in this case, which can be mounted on a printed circuit board (PCB) motherboard of the signal processing device, for example in a modular manner. The mounting or carrier faces on the stack outer side of the outer limbs are provided in this case with contact points (contact pads) for electrical coupling and/or coupling for signal purposes to the electronics of the signal processing device and/or to a battery of the hearing aid, for example.

In one suitable development, the first printed circuit board section is reinforced in such a way that, in the bent state of the stacked configuration, it runs in a straight line and parallel to the stacking direction. In other words, the first printed circuit board section runs substantially perpendicularly to the limbs of the stacked configuration. The first printed circuit board section is formed in this case in the manner of a book spine by the reinforcement, in particular with respect to the outer limbs. On one hand, a particularly stable stacked configuration is therefore realized by the reinforcement. On the other hand, the rectilinear configuration of the first printed circuit board section translates particularly advantageously to a configuration of the printed circuit board with a reduced installation space.

In contrast to the prior art, the printed circuit board section that connects the outer limbs to one another is therefore not arched or C-shaped. The reinforcement advantageously and easily prevents bending (curving, arching) of the first printed circuit board section, with the result that there is no disadvantageous restriction of the installation space bordered by the section in the stacked configuration. As a result, a higher packing density of the components in the stacked configuration is made possible, as a result of which the physical size of the printed circuit board is reduced. As a consequence, this advantageously translates to a reduction in the manufacturing costs and physical size of the signal processing device and of the hearing aid. In particular, particularly simple integration into an automated processing operation and/or mounting or manufacturing of the hearing aid is possible.

In one advantageous configuration, the outer limbs and the first printed circuit board section are constructed in an approximately U-shaped manner with two substantially right-angled corner regions. Due to the reinforcement, substantially only the corner regions of the first printed circuit board section are flexible, with the result that, during bending or folding of the printed circuit board, corner regions having a particularly small bending radius are substantially automatically formed. Particularly simple and installation space-saving mounting of the printed circuit board is made possible by the substantially right-angled U shape of the outer contour of the stacked configuration. In one possible configuration, the corner regions each have a bending radius between 0.1 mm (millimeter) and 0.3 mm, for example. The bending radius is preferably as close as possible to 0 mm, with the result that a substantially right angle (90°) is formed between the reinforced printed circuit board section and the respective outer limbs.

The reinforcement for guiding the first printed circuit board section in a straight line is realized, for example, by a material thickening or by additionally applied or fastened support or reinforcement elements, for example in the form of a number of separate reinforcement strips. It is important that a reinforcing effect is realized so that bending of the first printed circuit board section in the course of folding the stacked configuration is prevented as far as possible.

In one preferred embodiment, the first printed circuit board section is provided with an inner and/or outer reinforcement plate for this purpose. Inner or inner-side and outer or outer-side in this case refer in particular to the orientation of the surfaces of the first printed circuit board section with respect to the bent stacked configuration. The stable or rigid reinforcement plates in this case are fastened to the bending region of the flexible first printed circuit board section, with the result that the flexibility or bending ability in this region is reduced. The first printed circuit board section in the stacked configuration is guided in a straight line and stabilized by the reinforcement plates.

In one possible embodiment, the or each reinforcement plate is made of copper. This ensures a particularly cost-effective and simple production of the compact stacked configuration.

For example, it is conceivable in this case for the copper plates to serve only for mechanical stabilization and reinforcement. In other words, the copper plates are not electrically conductively coupled to the components of the printed circuit board. As a result, the copper plates act, for example, as protection against electromagnetic fields generated during operation of the printed circuit board, which advantageously translates to the electromagnetic compatibility (EMC) of the signal processing device.

In one expedient development, the or each reinforcement plate is, however, embodied in particular as a contact region of the printed circuit board. For example, it is conceivable in this case for the reinforcement plates to be provided with contact or soldering points (power plate) or to be embodied for grounding the components (ground plate).

An additional or alternative configuration provides a coating of the first printed circuit board section. The coating is preferably a curable epoxy or laminate. The coating is additionally or alternatively provided on the reinforcement plates, for example. However, combined variants are also conceivable, in which an outer-side reinforcement plate and an inner-side coating are applied to the first printed circuit board section, for example. This ensures a particularly reliable and stable mechanical reinforcement of the first conductor track section.

In one possible embodiment, the coating is applied to the first printed circuit board section in the unfolded or unbent state of the printed circuit board. The coating is then cured, as a result of which the first printed circuit board section is reinforced. The printed circuit board is then folded to form the stacked configuration. This permits particularly simple mounting of the printed circuit board with a reduced number of components.

An additional or further aspect of the invention provides for an electronic component of the signal processing device to be disposed in a cut-out or bordered region between the outer limbs and the first printed circuit board section. The electronic component preferably takes up a comparatively large amount of installation space so that the region cut out by the reinforcement of the first conductor track section, in which the reinforcement is embodied in particular in the manner of a book spine, is used in a particularly effective manner in terms of installation space. Furthermore, the mounted component preferably acts in a supporting, stabilizing and reinforcing manner, as a result of which the mechanical reinforcement of the first printed circuit board section is substantially improved. As a consequence, this advantageously translates to the stability of the stacked configuration and of the printed circuit board.

In one expedient embodiment, the electronic components are mounted to the printed circuit board of the signal processing device by using SMD (surface-mounted device) technology. This ensures a particularly simple and cost-effective production of the hearing aid.

With the objects of the invention in view, there is concomitantly provided a signal processing device being suitable and configured for use in a hearing aid. In this case, the signal processing device has a G-shaped or e-shaped bent flexible printed circuit board, and the printed circuit board section of the printed circuit board that connects the outer limbs and is preferably in the form of a book spine is reinforced. As a result, the most compact possible signal processing device with the most reduced installation space possible is realized, which advantageously translates to a reduction in the physical size of the hearing aid equipped with the device.

Other features which are considered as characteristic for the invention are set forth in the appended claims.

Although the invention is illustrated and described herein as embodied in a hearing aid and a signal processing device for a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a hearing aid having an acoustoelectric transducer, a signal processing device and an electroacoustic transducer;

FIG. 2 is a vertical-sectional view of a motherboard of the signal processing device having a G-shaped folded printed circuit board in a first embodiment;

FIG. 3 is a vertical-sectional view of the motherboard of the signal processing device having the printed circuit board in a second embodiment;

FIG. 4 is a plan view directed onto a top side of the printed circuit board in a third embodiment in a non-folded state;

FIG. 5 is a plan view directed onto a bottom side of the printed circuit board of the third embodiment in a non-folded state;

FIG. 6 is a vertical-sectional view of the motherboard of the signal processing device having the printed circuit board in a fourth embodiment; and

FIG. 7 is a sectional view of the printed circuit board in a fifth embodiment.

### DETAILED DESCRIPTION OF THE INVENTION

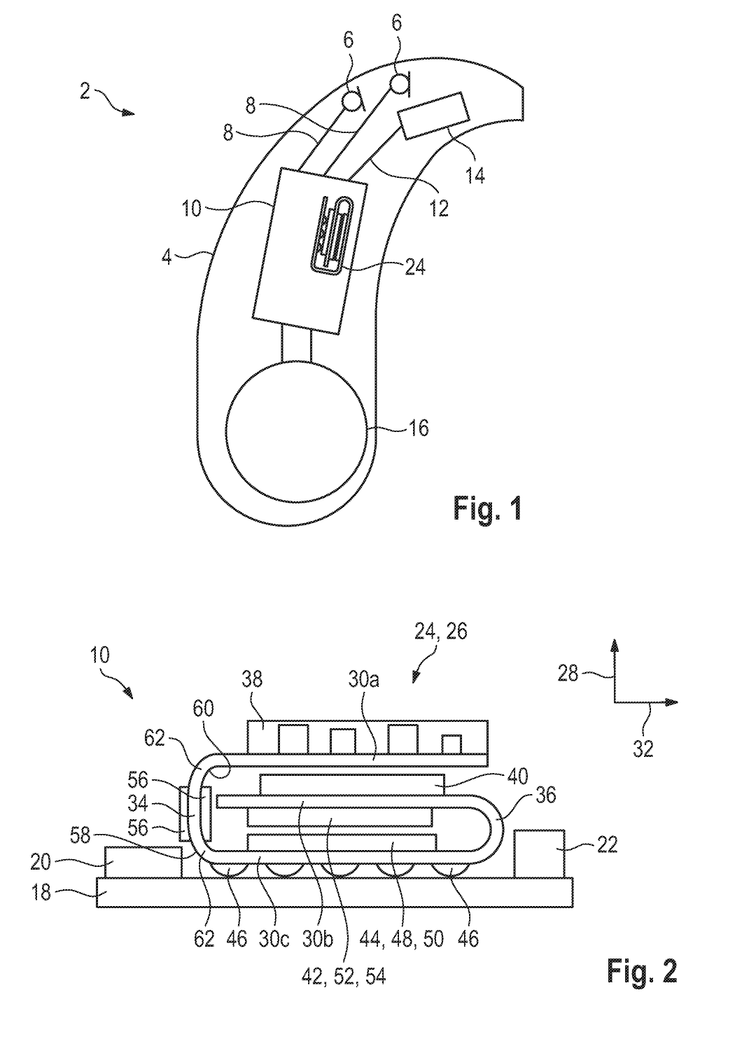

Referring now in detail to the figures of the drawings, in which mutually corresponding parts and sizes are always provided with the same reference numerals, and first, particularly, to FIG. 1 thereof, there is seen a basic structure of a hearing aid 2 according to the invention. In this exemplary embodiment, the hearing aid 2 is constructed as a behind-the-ear (BTE) hearing aid. In this case, the hearing aid 2 includes a hearing aid housing 4, in which one or more microphones, also referred to as acoustoelectric transducers 6, are incorporated. The sound or the acoustic signals in the environment is/are recorded by using the microphones 6 and converted to an electrical audio signal 8.

The audio signal 8 is processed by a signal processing device 10, which is likewise disposed in the hearing aid housing 4. The signal processing device 10 generates an output signal 12 based on the audio signal 8. The output signal is conducted to a loudspeaker or receiver 14. The receiver 14 is embodied in this case as an electroacoustic transducer 14, which converts the electrical output signal 12 to an acoustic signal and outputs the acoustic signal. In the BTE hearing aid 2, the acoustic signal is transmitted to the eardrum of a hearing aid user, possibly through a sound tube that is not illustrated in more detail or an external receiver that is fixed by using an ear mold seated in the auditory canal. However, an electromechanical transducer, for example, is also conceivable as the receiver 14, such as a bone-conduction receiver, for example.

The power supply for the hearing aid 2 and in particular for the signal processing device 10 is provided by a battery 16 that is housed in the hearing aid housing 4.

FIG. 2 illustrates the signal processing device 10 in section. The signal processing device 10 has a PCB (printed circuit board) as a motherboard 18, which is mounted with electronic component parts 20, 22, such as an AMR (audio modem riser), for example, and with an approximately G-shaped or e-shaped folded (bent) printed circuit board 24. The printed circuit board 24 is at least partially embodied as a flexible printed circuit board (flexible circuit), for example based on a polyamide film, to provide for simplified folding or bending of the printed circuit board 24.

The folding of the printed circuit board 24, which is also referred to below as a stacked configuration 26, has three horizontal limbs 30a, 30b and 30c disposed above one another along a stacking direction 28 with each limb being spaced apart from one another. The limbs 30a, 30b and 30c are oriented in a straight line and parallel along a limb direction 32, which is directed substantially parallel to the surface of the motherboard 18 in the mounted state. The stacking direction 28 in this case is aligned substantially perpendicularly to the limb direction 32.

The outer limbs 30a and 30c of the stacked configuration 26 are connected by a printed circuit board section 34. The outer limb 30c is further connected to the middle limb 30b by an approximately arched printed circuit board section 36. The limbs 30a, 30b and 30c in this case are embodied as stable printed circuit board sections, for example, which are comparatively inflexible as compared to the flexible printed circuit board sections 34 and 36.

The limbs 30a, 30b and 30c are provided with electronic components 38, 40, 42, 44 of the printed circuit board 24 in the mounted state. The limb 30c has contact points 46 on the motherboard side, for example in the form of soldering pads, with which the printed circuit board 24 and the components 38, 40, 42, 44 thereof are electrically coupled and coupled for signal purposes to the motherboard 18. An application-specific integrated circuit (ASIC) 48 and electronic component parts 50 as components 44 are applied to the opposite (inner) plane side of the limb 30c by using SMD technology.

The side of the limb 30b that faces the limb 30c carries the components 42 in this exemplary embodiment. The components 42 include an ASIC 52 and electronic component parts 54. The limb 30c is provided with a number of electronic (SMD) component parts as components 40 toward the limb 30a. The limb 30a carries the components 38 on the outer side, that is to say on the top side facing away from the interior of the stacked configuration 26. The components include a number of electronic (SMD) component parts, for example passive component parts such as resistors, capacitors or coils.

The printed circuit board section 34 connecting the limbs 30a and 30c is embodied to be reinforced along the stacking direction 28. In particular, the printed circuit board section 34 has a substantially rectilinear profile along the stacking direction 28. In this exemplary embodiment, the otherwise flexible printed circuit board section 34 is mechanically reinforced in sections by using two approximately right-angled reinforcement plates 56. For this purpose, the reinforcement plates 56 made of copper are fastened on the outer side 58 and inner side 60—in relation to the stacked configuration 26—of the printed circuit board section 34, for example adhesively bonded in a cohesive manner. The printed circuit board section 34 is stabilized in sections by the reinforcement plates 56, that is to say it is restricted in terms of its bending ability or folding ability or flexibility.

A configuration in the manner of a book spine is realized for the printed circuit board 24 by way of the reinforcement plates 56. In other words, the printed circuit board 24 is thereby reinforced in the printed circuit board section 34 in such a way that, during folding or bending to form the stacked configuration 26, the limbs 30a and 30c and the reinforced printed circuit board section 34 have an approximately right-angled U shape, wherein the limbs 30a and 30c form a vertical U limb and the printed circuit board section 34 forms a horizontal U limb. In this case, the regions of the printed circuit board section 34 that are not stabilized by the reinforcement plates 56 form approximately right-angled corner regions 62 in the folded state.

The printed circuit board section 34 is therefore straightened or made to run in a straight line by the mechanical reinforcement thereof. In particular, two comparatively right-angled bends of the corner regions 62 are made possible as a result. The corner regions 62 preferably have bending radii of close to 0 mm in this case. As a result, additional installation space is provided in the stacked configuration 26 and the packing size or physical size of the printed circuit board 24 is advantageously reduced. In one possible alternative embodiment, only the outer side 58 or the inner side 60 is provided with a reinforcement plate 56, for example.

In this embodiment, the reinforcement plates 56 are only mechanically fastened to the printed circuit board section 34 and are not further electrically contact-connected to the printed circuit board 24. The reinforcement plates 56 act in this case, for example, as protection against electromagnetic fields as part of an improved EMC of the signal processing device 10.

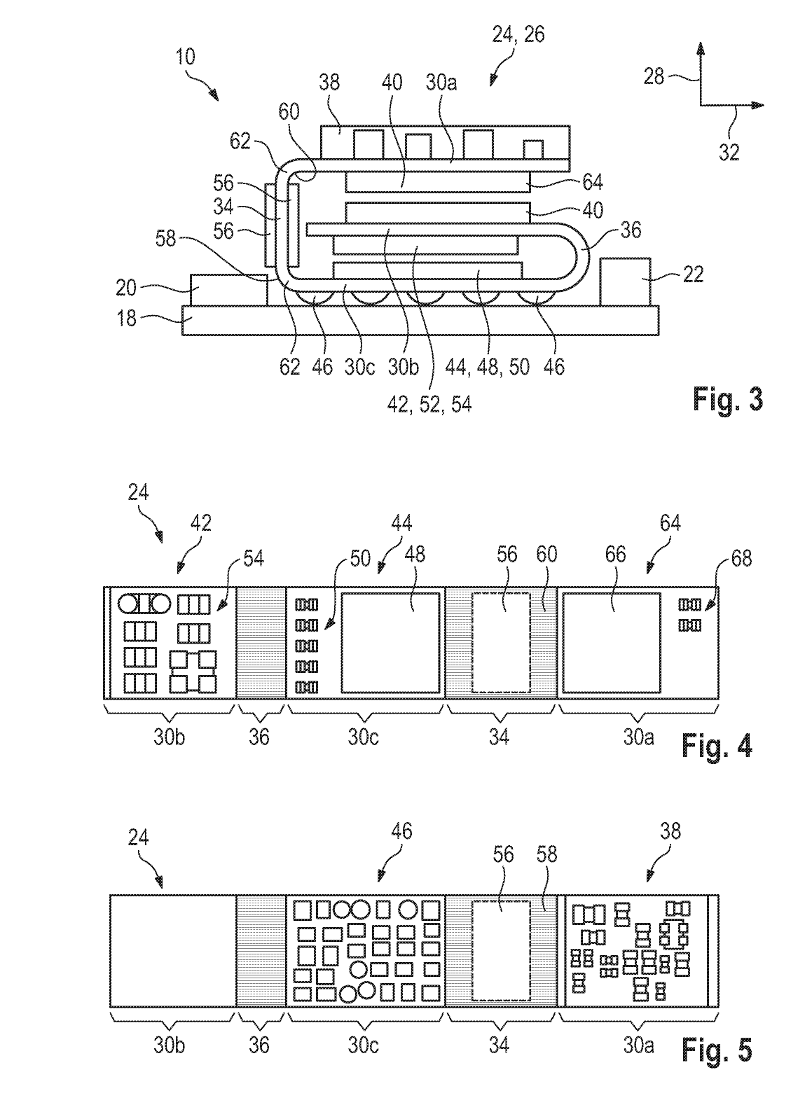

In the exemplary embodiment of FIG. 3, the printed circuit board 24 has a printed circuit board section 34 that is longer along the stacking direction 28 as compared to the embodiment described above, and the printed circuit board section has correspondingly longer reinforcement plates 56. As a result, additional installation space is provided within the stacked configuration 26, which, in this exemplary embodiment, serves to contact-connect electronic components 64 to the plane side of the limb 30a that faces the limb 30b. In this exemplary embodiment, the printed circuit board 24 is embodied in one piece as a flexible printed circuit board (flexible circuit). In this embodiment, the reinforcement plates 56 are configured, for example, as ground plates, with the result that it is possible to ground the components 38, 40, 42, 44, 64 by using the reinforcement plates 56. For example, it is also conceivable for the reinforcement plates 56 to have contact or soldering points for electrical contact-connection and/or contact-connection for signal purposes and for fastening electronic components.

FIGS. 4 and 5 show plan views of a third embodiment of the printed circuit board 24 which are directed onto the top side (FIG. 4) and onto the bottom side (FIG. 5). The printed circuit board 24 has a flat or thin, approximately right-angled basic shape. This exemplary embodiment is configured in a similar way to the embodiment of FIG. 2, wherein the limb 30a is provided with the components 64 and for that reason the components 40 of the limb 30b are omitted. In this case, the components 64 of the limb 30a have an ASIC 66 and electronic (SMD) component parts 68. The reinforcement plates 56 are drawn in the figures using only dotted lines.

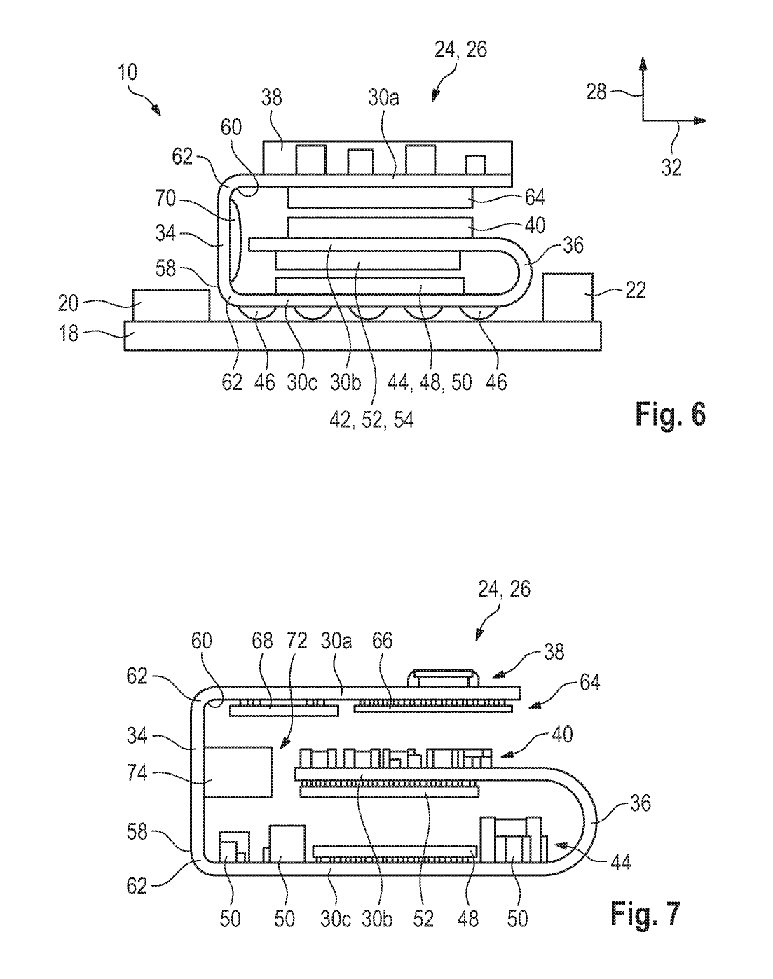

The exemplary embodiment of FIG. 6 illustrates an alternative configuration of the exemplary embodiment in FIG. 3. In this embodiment, the book spine-like printed circuit board section 34 is stabilized by using a coating 70 instead of reinforcement plates 56. The coating 70 is preferably a curable epoxy or laminate, which, in this exemplary embodiment, is applied only to the inner side 60, for example. To this end, the coating 70 is applied to the region of the printed circuit board section 34 that is to be reinforced in a non-folded state of the printed circuit board 24 and is then cured. The printed circuit board 24 is then folded to form the stacked configuration 26.

The printed circuit board 24 illustrated in FIG. 7 has a comparatively short limb 30b. As a result, additional installation space is generated in a cut-out or bordered region 72 between the limbs 30a and 30c and the printed circuit board section 34. An electronic component 74 that takes up a comparatively large amount of installation space is disposed in this region 72, the component being contact-connected to the printed circuit board section 34.

In this exemplary embodiment, the printed circuit board section 34 is stabilized only by mounting the component 74. In other words, the mounted or contact-connected component 74 acts in a reinforcing manner on the printed circuit board section 34. This means that, in addition to the six surfaces of the limbs 30a, 30b and 30c, the inner and outer faces of the printed circuit board section 34 are also suitable and configured for the configuration of electronic components and/or contact points. As a result, a particularly compact printed circuit board 24 and stacked configuration 26 with a reduced amount of components is realized.

Alternatively or in addition, it is conceivable, in one possible embodiment, to combine a stabilizing component 74 of this type with a reinforcement plate 56 and/or a coating 70, in order to create a particularly stable printed circuit board section 34 that is reinforced in the manner of a book spine.

In one suitable dimensioning, the corner regions 62 preferably have a bending radius between 0.1 mm and 0.3 mm. The stacked configuration 26 of the printed circuit board 24 suitably has a length of approximately 4.85 mm, a width of approximately 3.71 mm and a height of approximately 1.95 mm. As a result, the printed circuit board 24 is particularly space-saving, which advantageously translates to a reduction in the physical size of the signal processing device 10 and of the hearing aid 2.

The invention is not limited to the exemplary embodiments described above. On the contrary, it is also possible for other variants of the invention to be derived by a person skilled in the art without departing from the subject matter of the invention. In particular, all individual features described in connection with the exemplary embodiments can, furthermore, also be combined with one another in a different way without departing from the subject matter of the invention.

It is important, on one hand, that the limbs 30a, 30b and 30c are spaced apart from one another so that as many carrying or mounting faces as possible are formed for the electronic components 38, 40, 42, 44, 64. On the other hand, the printed circuit board section 34 is embodied to be reinforced in this way so that the smallest possible bending radii of the corner regions 62 in the course of folding of the stacked configuration 26 are possible. This reduces the physical size of the stacked configuration 26 and of the printed circuit board 24, which consequently advantageously translates to a reduction in the physical size of the signal processing device 10 and of the hearing aid 2.

The hearing aid 2 can also be embodied as an in-the-ear hearing aid or else as a binaural hearing aid, for example. In principle, it is likewise conceivable to use a signal processing device according to the invention in headphones or a headset as well, for example wearable or personal sound amplification products (WSAP, PSAP) as well.

1. A hearing aid, comprising:
an acoustoelectric transducer and an electroacoustic transducer;
a signal processing device connected to said acoustoelectric transducer and to said electroacoustic transducer, said signal processing device having a flexible printed circuit board being bent to form an approximately G-shaped stacked configuration;
said stacked configuration of said printed circuit board having three horizontal limbs being disposed above one another along a stacking direction and being spaced apart from one another along said stacking direction, said horizontal limbs including outer horizontal limbs and a middle limb;
a first printed circuit board section interconnecting said outer horizontal limbs, said first printed circuit board section being reinforced along said stacking direction;
a second printed circuit board section interconnecting one of said outer limbs and said middle limb; and
electronic components disposed on said printed circuit board.

2. The hearing aid according to claim 1, wherein said first printed circuit board section is reinforced to run in a straight line and parallel to said stacking direction in a bent state of said stacked configuration.

3. The hearing aid according to claim 1, wherein said outer limbs and said first printed circuit board section are approximately U-shaped and have two substantially right-angled corner regions.

4. The hearing aid according to claim 1, wherein said first printed circuit board section is provided with at least one of an inner or an outer reinforcement plate.

5. The hearing aid according to claim 4, wherein said reinforcement plate is made of copper.

6. The hearing aid according to claim 4, wherein said reinforcement plate is a contact region of said printed circuit board.

7. The hearing aid according to claim 1, wherein said first printed circuit board section is provided with a coating.

8. The hearing aid according to claim 1, wherein said outer limbs and said first printed circuit board section define a cut-out region therebetween, and said signal processing device includes an electronic component disposed in said cut-out region.

9. The hearing aid according to claim 1, wherein said electronic components are mounted on said printed circuit board of said signal processing device by SMD technology.

10. A signal processing device of a hearing aid, the signal processing device comprising:
a flexible printed circuit board being bent in a G-shape;
said printed circuit board having outer limbs and a middle limb;
said printed circuit board having a printed circuit board section interconnecting said outer limbs; and
said printed circuit board section being reinforced.
